(19) United States
(12) Patent Application Publication
(10) Pub. No.: US 2006/0123232 A1
(43) Pub. Date: Jun. 8, 2006

(54) Method for protecting and managing retention of data on worm media

(75) Inventors: David M. Cannon, Tucson, AZ (US); Toby L. Marek, Santa Clara, CA (US); Howard N. Martin, Vail, AZ (US); David R. Minch, Tucson, AZ (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/007,474

(22) Filed: Dec. 8, 2004

(51) Int. Cl. H04L 9/00

(52) U.S. Cl. 713/165

(57) ABSTRACT

A policy-based retention manager provides protection and management of files in a WORM file volume. The protection of the files is accomplished by the manager establishing a volume retention period for securely storing the files within the WORM file volume on a WORM media (e.g., a WORM disk media) based on a file retention end date of each file within the WORM file volume, and securely storing the WORM file volume on the WORM media during the volume retention period. The management of the files is accomplished by the manager establishing a volume reclamation period for reclaiming unexpired files within the WORM file volume prior to an expiration of the volume retention period, and reclaiming each unexpired file within the WORM file volume from the WORM media during the volume reclamation period.

### FIELD OF INVENTION

The present invention generally relates to storage-management software applications that provide a repository for computer information that is backed up, archived, or migrated from client nodes in a computer network. The present invention specifically relates to an extension of such storage-management software applications to support storage-management hardware applications that implement a WORM state (i.e., write once, read many) to protect the storage of data for a specified period of time.

### BACKGROUND OF THE INVENTION

Storage-management software applications can provide a storage-management server with a capability of storing files (i.e., data objects) in one or more storage pools and a capability of using its own database for tracking information about the stored files. Each stored file is bound to a “policy” that manages the life cycle of the stored file where the policy describes storage parameters for the stored file (e.g., storage device destination and number of copies) and where the policy describes life cycle parameters of the stored file (e.g., file retention period).

Storage-management hardware applications can provide protection for a file stored therein for a specified period of time by providing a storage-management server with a capability to set the file to a WORM state for securely storing the file within the storage volume. The length of time the file is retained is commonly referred to as the retention period. Once the file volume is committed to the WORM state, access to the stored file is immutable where the stored file can only be deleted from the hardware application upon expiration of the file retention period.

A challenge therefore for the computer industry is to develop techniques for extending known storage-management software applications to support known storage-management hardware applications that implement a WORM state (i.e., write once, read many) for the protection of files stored therein for a specified period of time should a portion of the file need to be protected past the established file retention period.

### SUMMARY OF THE INVENTION

The following terms are defined for purposes of facilitating an understanding of the present invention by those having ordinary skill in the art.

First, the term “WORM media” is broadly defined herein as any storage-management hardware application that provides delete protection for a file stored therein for a specified period of time, and the term “WORM disk media” is broadly defined herein any storage-management disk-based application that provides delete protection for a file stored therein for a specified period of time.

Second, the term “unexpired file” is broadly defined herein as a file that has yet to reach its expiration date, and the term “expired file” is broadly defined herein as a file that has reached its expiration date.

Third, the term “file retention end date” is broadly defined herein as an expiration date of a specific file.

Fourth, the term “volume retention end date” is broadly defined herein as the latest file retention end date of any file stored on a volume.

Fifth, the term “volume retention period” is broadly defined herein as a period of time that a volume is securely protected by WORM disk media where the date which corresponds to the last day of the volume retention period is the volume retention end date.

Finally, the term “volume reclamation period” is broadly defined herein as an interval of the volume retention period wherein files that have not expired are removed from a volume prior to its volume retention end date and stored on a new volume having a later volume retention end date. The first day of the volume reclamation period is the volume reclamation begin date. The last day of the volume reclamation period is the volume reclamation end date, which may be earlier than or identical to the volume retention end date.

The present invention provides a new and unique method for protecting and managing files stored on a WORM file volume.

One form of the present invention is a signal bearing medium tangibly embodying a program of machine-readable instructions executable by one or more processor(s) to perform operations to protect and manage files within a WORM file volume. The operations include (1) establishing a volume retention period for securely storing the files within the WORM file volume on a WORM disk media based on a file retention end date of each file within the WORM file volume, (2) securely storing the WORM file volume on the WORM disk media during the volume retention period, (3) establishing a volume reclamation period for reclaiming unexpired files within the WORM file volume prior to an expiration of the volume retention period, and (4) reclaiming each unexpired file within the WORM file volume from the WORM disk media during the volume reclamation period.

A second form of the present invention is a system employing one or more processors, and one or more memories for storing instructions operable with the processor(s) for protecting and managing files within a WORM file volume. The instructions being executed for (1) establishing a volume retention period for securely storing the files within the WORM file volume on a WORM disk media based on a file retention end date of each file within the WORM file volume, (2) securely storing the WORM file volume on the WORM disk media during the volume retention period, (3) establishing a volume reclamation period for reclaiming unexpired files within the WORM file volume prior to an expiration of the volume retention period, and (4) reclaiming each unexpired file within the WORM file volume from the WORM disk media during the volume reclamation period.

A third form of the present invention is a server for protecting and managing files within a WORM file volume. The server includes (1) means for establishing a volume retention period for securely storing the files within the WORM file volume on a WORM disk media based on a file retention end date of each file within the WORM file volume, (2) means for securely storing the WORM file volume on the WORM disk media during the volume retention period, (3) means for establishing a volume reclamation period for reclaiming unexpired files within the WORM file volume prior to an expiration of the volume retention period, and (4) means for reclaiming each unexpired file within the WORM file volume from the WORM disk media during the volume reclamation period.

The forgoing forms and other forms, objects, and aspects as well as features and advantages of the present invention will become further apparent from the following detailed description of various embodiments of the present invention, read in conjunction with the accompanying drawings. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates an exemplary operational environment for a policy-based retention manager in accordance with the present invention;

FIG. 2 illustrates a flowchart representative of one embodiment of a policy-based WORM retention method in accordance with the present invention;

FIG. 3 illustrates a flowchart representative of one embodiment of WORM file volume construction method in accordance with the present invention;

FIG. 4 illustrates an exemplary execution of the flowchart illustrated in FIG. 3;

FIG. 5 illustrates a flowchart representative of one embodiment of WORM file volume storage method in accordance with the present invention;

FIG. 6 illustrates an exemplary execution of the flowchart illustrated in FIG. 5;

FIG. 7 illustrates a flowchart representative of one embodiment of WORM disk file volume reclamation method in accordance with the present invention; and

FIG. 8 illustrates an exemplary execution of the flowchart illustrated in FIG. 7.

### DETAILED DESCRIPTION OF THE PRESENT INVENTION

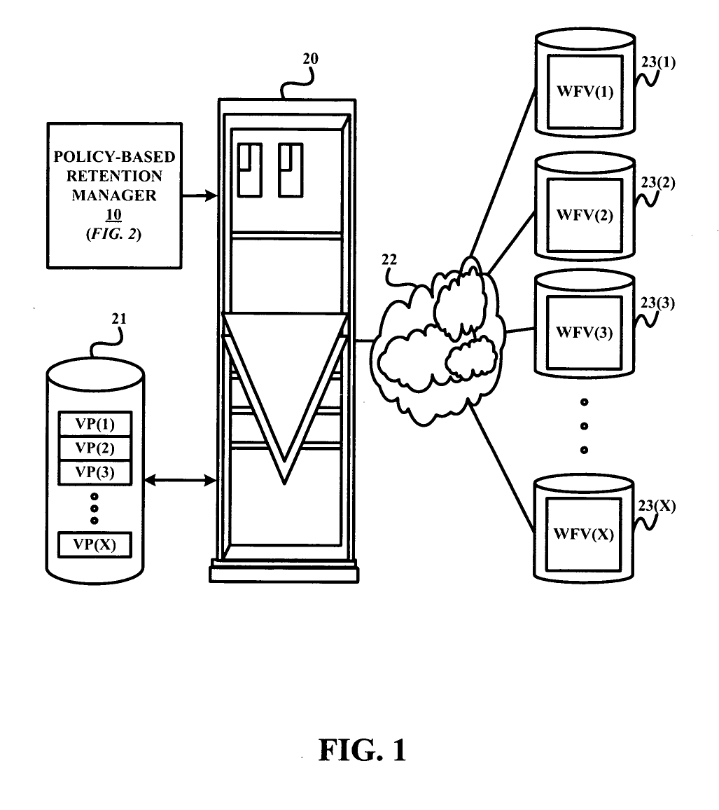

A policy-based WORM retention in accordance with the present invention combines the advantages of a file retention period for a file stored on a media and a volume retention period for a WORM file volume stored on a WORM media. Specifically, a policy-based WORM retention in accordance with the present invention ensures protection of files within a WORM file volume stored on a WORM media during a volume retention period set for that WORM media and transfer of unexpired files within the WORM file volume during a volume reclamation period set for that WORM disk media. The method is based on a recognition that it will be a rare occurrence that all files stored on that WORM media will have the same file retention period. To this end, as illustrated in FIG. 1, the present invention therefore offers a policy-based retention manager 10 that is structurally configured with software, hardware and/or firmware for implementing a policy-based WORM retention in accordance with the present invention.

Referring to FIG. 1, manager 10 is installable on a conventional server 20 connected via a conventional network 22 to X number of conventional WORM disk media 23(1)-23(X), where X≧1. As shown, manager 10 facilitates a storage of WORM file volumes WFV(1)-WFV(X) by server 20 on respective WORM disk media 23(1)-23(X) with a storage of a corresponding volume policy VP(1)-VP(X) by server 20 on a database 21. Each WORM file volume WFV(1)-WFV(X) is an aggregate of files managed as a single file volume on a respective WORM disk media 23(1)-23(X) where manager 10 manages WORM disk media retention period for WORM file volumes WFV(1)-WFV(X) and retention periods of each file stored within the respective WORM file volumes WFV(1)-WFV(X). Each volume policy VP(1)-VP(X) includes information indicative of a volume retention period for securely storing respective WORM file volume WFV(1)-WFV(X) on respective WORM disk media 23(1)-23(X), and information indicative of a volume reclamation period for reclaiming each file having an unexpired file retention period on a respective WORM file volume WFV(1)-WFV(X) prior to an expiration of the respective volume retention period.

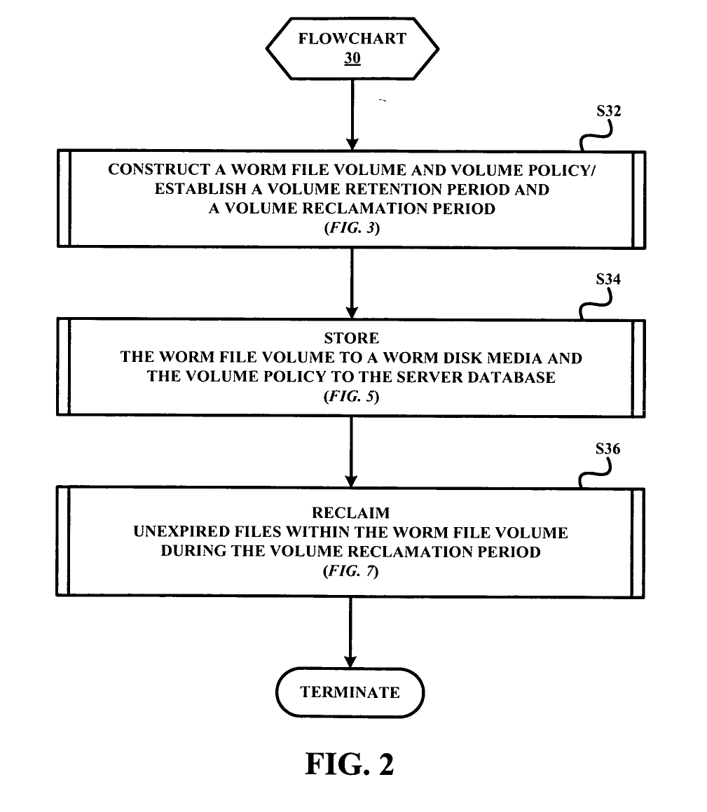

An implementation of the policy-based WORM retention in accordance with the present invention will now be described in detail herein. To facilitate an understanding of the present invention, the implementation of the policy-based WORM retention will be described in the context of an execution of a flowchart 30 (FIG. 2) by manager 10 involving eight (8) files A-H received by server 20 in a batch file transfer of files A-H from a single client across a suitable network (e.g., a TCP/IP based network) on Jan. 1, 2005. However, from this straightforward description of the execution of flowchart 30 by manager 10, those having ordinary skill in the art will appreciate the implementation of the policy-based WORM retention of the present invention in the context of server 20 receiving numerous files in numerous file transfers from numerous clients across one or more networks. Those having ordinary skill in the art will further appreciate a storage of a file on a WORM disk media can be performed in one of a variety of techniques, such as, for example, in an internal data-movement operation (e.g., migrating data from a fast disk to a slower disk in a storage hierarchy) and in a data transfer to a new storage device.

Furthermore, in practice, multiple WORM file volumes can be stored on a WORM disk media. Thus, from the following straightforward description of the execution of flowchart 30 by manager 10, those having ordinary skill in the art will appreciate the implementation of the policy-based WORM retention of the present invention in the context of one or more of WORM disk media 23 storing multiple WORM file volumes WFV.

Referring to FIG. 2, a stage S32 of flowchart 30 encompasses a construction of a WORM file volume and a respective volume policy, and an establishment of a volume retention period and a volume reclamation period corresponding to the WORM file volume. In practice, the manner by which manager 10 implements stage S32 is without limit. Therefore, the description of the following embodiment of stage S32 is not a limitation as to the scope of stage S32.

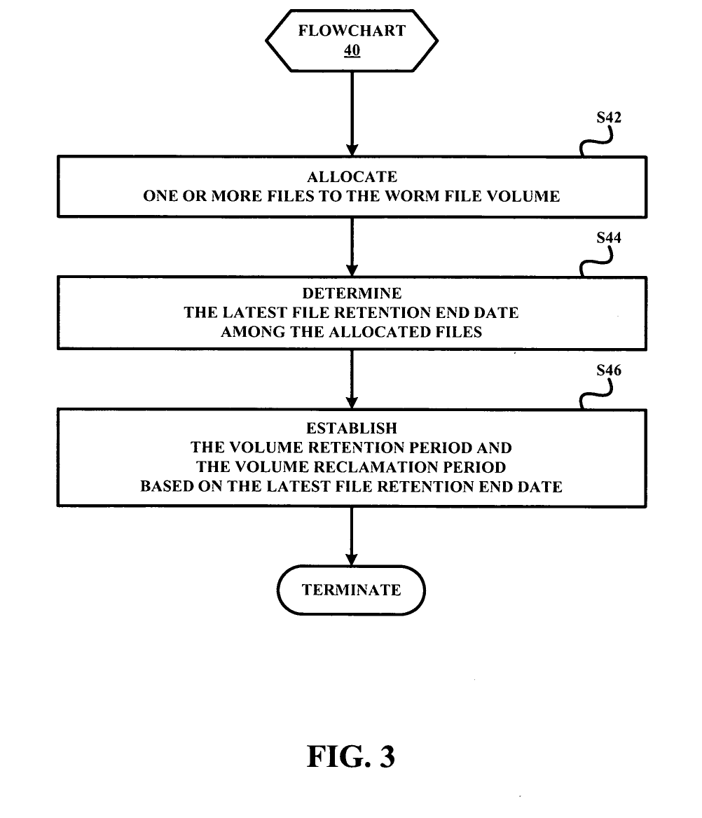

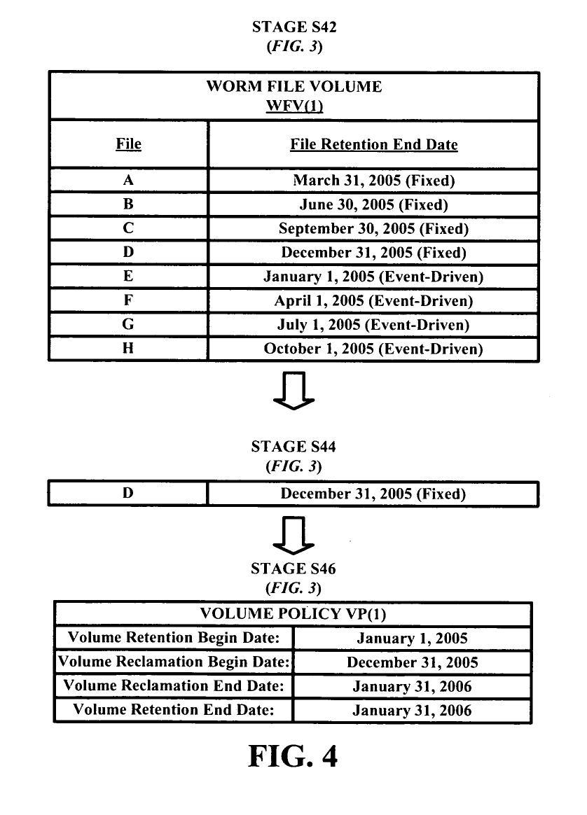

FIG. 3 illustrates a flowchart 40 as one embodiment of stage S32 (FIG. 2). A stage S42 of flowchart 40 encompasses an allocation of files A-H to a WORM file volume. For example, manager 10 may construct WORM file volume WFV(1) from an exemplary listing of files of A-H and their file retention end dates as shown in FIG. 4, and initiate a construction of a respective volume policy VP(1) having storage parameters and life cycle parameters for WORM file volume WFV(1) (not shown). Those having ordinary skill in the art will appreciate that a file can have one of various forms of retention end dates, including, but not limited to, a fixed file retention end date as shown for files A-D or an event-driven retention end date as shown for files E-H.

A stage S44 of flowchart 40 encompasses a determination of the latest file retention end date among the allocated files A-H. For example, manager 10 would determine that file D has the latest file retention end date of Dec. 31, 2005, as shown in FIG. 4.

A stage S46 of flowchart 40 encompasses an establishment of the volume retention period and the volume reclamation period based on the latest file retention end date. In one embodiment, manager 10 uses the latest file retention end date as a volume reclamation begin date, adds Y time (e.g., seconds, minutes, hours, days) to the latest file retention end date to obtain a volume reclamation end date, where Y≧1 time unit, and adds Z time (e.g., seconds, minutes, hours, days) to the volume reclamation end date to obtain a volume retention end date, where Z≧0 time unit. In particular, Y time is sufficient time to reclaim all unexpired files on the WORM volume beginning on the volume reclamation begin date. For example, as shown in FIG. 4, manager 10 would use Dec. 31, 2005, of file D as the volume reclamation begin date and manager 10 could add one (1) month to Dec. 31, 2005, to obtain the volume reclamation end date of Jan. 31, 2006, and add zero (0) time to the volume reclamation end date to obtain the volume retention end date of Jan. 31, 2006. All of these dates are included with other life cycle parameters and storage parameters in volume policy VP(1).

Flowchart 40 is terminated upon completion of stage S46. Upon termination of the flowchart 40, WORM file volume WFV(1) will contain allocated files A-H, the volume retention period for securely storing WORM file volume WFV(1) on a WORM disk media will be contained within the volume policy VP(1), and the volume reclamation period for reclaiming unexpired files within the WORM file volume WFV(1) prior to an expiration of the volume retention period will be contained within the volume policy VP(1).

Referring again to FIG. 2, a stage S34 of flowchart 30 encompasses a storage of files A-H as a WORM file volume to a WORM disk media and a storage of a respective volume policy to the server database 21 (FIG. 1). In practice, the manner by which manager 10 implements stage S34 is without limit. Therefore, the description of the following embodiment of stage S34 is not a limitation as to the scope of stage S34.

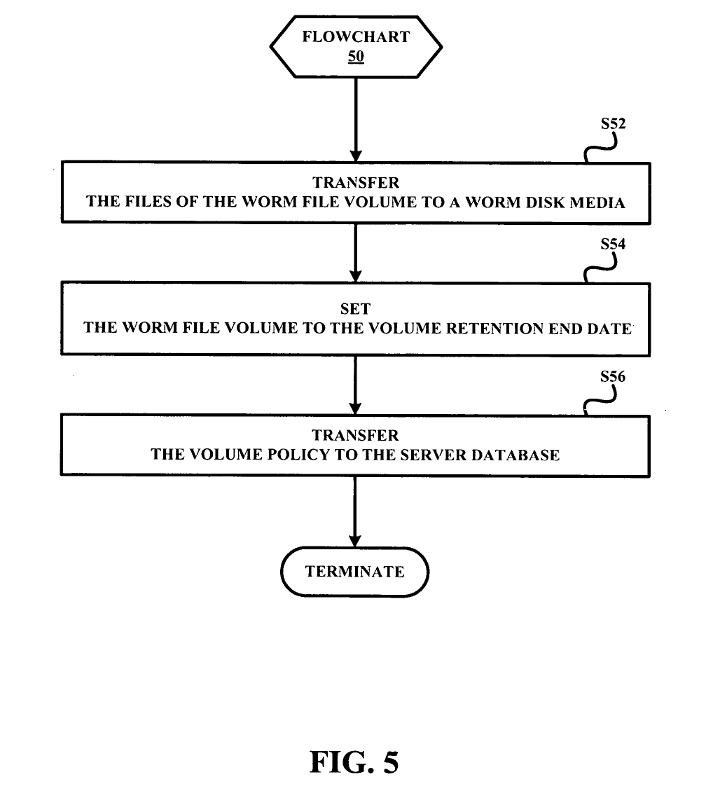

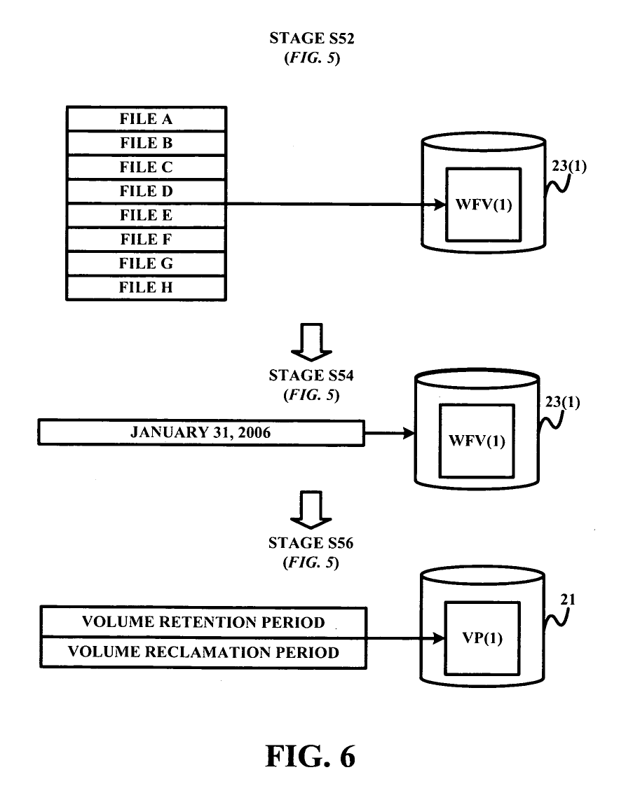

FIG. 5 illustrates a flowchart 50 as one embodiment of stage S34 (FIG. 2). A stage S52 of flowchart 50 encompasses a transfer of the files A-H of a WORM file volume to a WORM disk media. Files A-H can be transferred individually, in groups or a collective whole in dependence upon the creation of the corresponding WORM file volume. For example, manager 10 could transfer files A-H of WORM file volume WFV(1) to WORM disk media 23(1) as shown in FIG. 6.

A stage S54 of flowchart 50 encompasses a setting of WORM file volume WFV(1) to the volume retention end date. For example, manager 10 would set WORM file volume WFV(1) to the volume retention end date of Jan. 31, 2006, as shown in FIG. 6.

A stage S56 of flowchart 50 encompasses a transfer of the volume retention period and the volume reclamation period as life cycle parameters of a volume policy to server database 22. For example, manager 10 could transfer file volume retention period and the volume reclamation period as life cycle parameters of volume policy VP(1) previously stored to server database 22 as shown in FIG. 6.

Flowchart 50 is terminated upon completion of stage S56. Upon termination of the flowchart 50, the files A-H will be contained in WORM file volume WFV(1) stored on WORM file media 23(1). Furthermore, the volume policy VP(1) as stored on server database 22 will additionally contain information indicative of the volume retention period for securely storing WORM file volume WFV(1) on WORM file media 23(1) and the volume reclamation period for reclaiming unexpired files within WORM file volume WFV(1) as stored on WORM file media 23(1) prior to an expiration of the volume retention period.

Referring again to FIG. 2, a stage S36 of flowchart 30 encompasses a reclaiming those files among files A-H during the volume reclamation period of files on the WORM file volume which have not expired. In practice, the manner by which manager 10 implements stage S36 is without limit. Therefore, the description of the following embodiment of stage S36 is not a limitation as to the scope of stage S36.

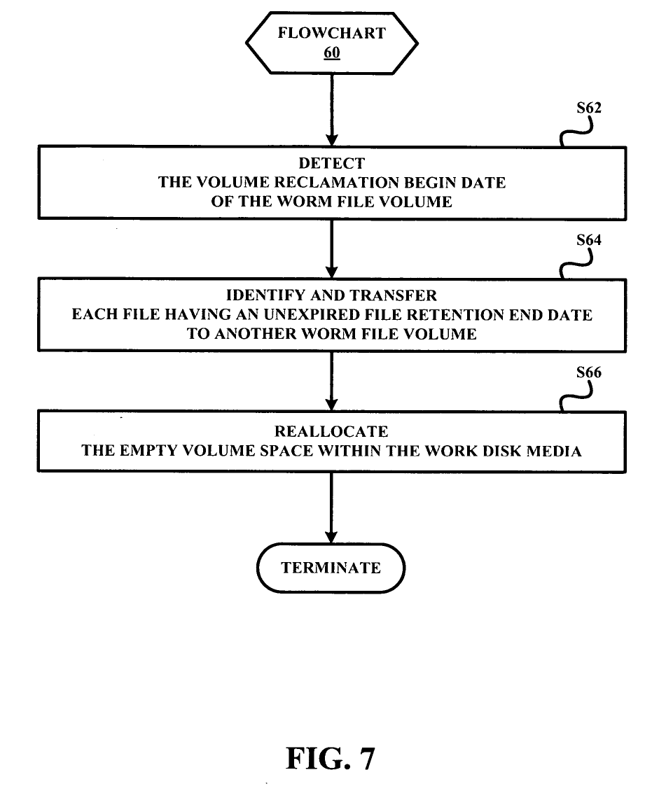

FIG. 7 illustrates a flowchart 60 as one embodiment of stage S36 (FIG. 2). A stage S62 of flowchart 60 encompasses a detection of the volume reclamation begin date of the WORM file volume. For example, manager 10 would detect an occurrence of the volume reclamation begin date of Dec. 31, 2005, for WORM file volume WFV(1) as indicated by manager 10 reading respectively volume policy VP(1).

Those having ordinary skill in the art would appreciate the dynamic nature of stage S62. First, each fixed retention period for files A-H would have expired prior to or would expire upon the volume reclamation begin date unless the respective fixed retention period was extended beyond the volume reclamation begin date prior to the detection of the volume reclamation begin date by manager 10. Second, each event-driven retention period for files E-H would have expired prior to or would expire upon the volume reclamation begin date unless the underlying event extended the respective event-driven retention period beyond the volume reclamation begin date prior to the detection of the volume reclamation begin date by manager 10.

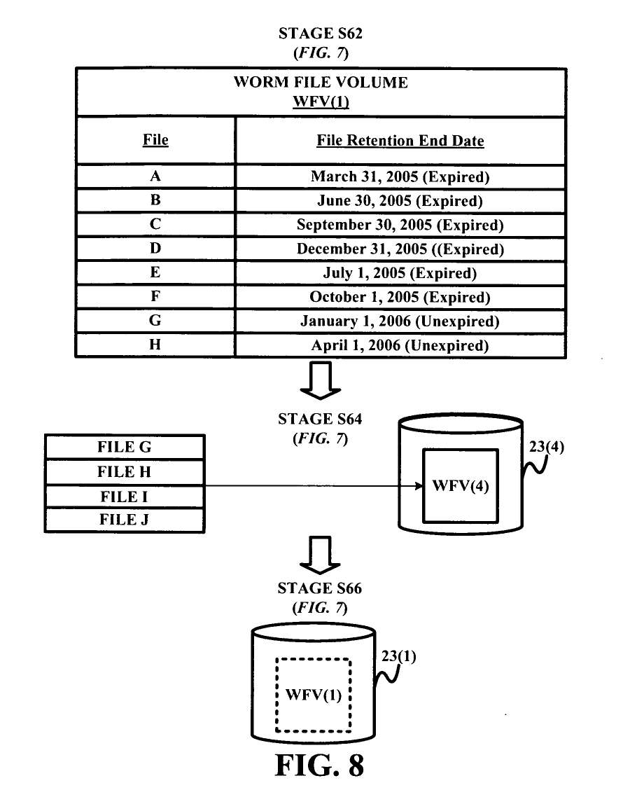

FIG. 8 shows an example where the unextended fixed retention end dates for files A-C expired prior to Dec. 31, 2005, and the unextended fixed retention end date of file D expired on Dec. 31, 2005. FIG. 8 further shows the event-driven extension end dates for files E-H were extended for three (3) months by underlying events prior to Dec. 31, 2005, where the extended event-drive retention end dates of files E and F expired prior to Dec. 31, 2005, and where the extended event-drive retention periods of files G and H were still unexpired as of Dec. 31, 2005.

A stage S64 of flowchart 60 encompasses a transfer of each file among files A-H having an unexpired file retention end date to another WORM file volume. For example, manager 10 could transfer files G and H to a WORM disk media 23(4) as a WORM file volume WFV(4) shown in FIG. 8. Such a transfer may undergo an additional execution of flowchart 30 (FIG. 2), whereby files G and H may be stored with additional files (e.g., files I and J as shown) within WORM file volume WFV(4) under the principles of the present invention.

A stage S66 of flowchart 60 encompasses a reallocation of the empty volume space of the WORM disk media previously storing files A-H. For example, manager 10 could conventionally delete files A-H from WORM file volume WFV(1) to enable future uses by manager 10 of the volume space occupied previously occupied by WORM file volume WFV(1) on WORM disk media 23(1) as represented by the dashed outline of WORM file volume WFV(1).

Flowchart 60 is terminated upon completion of stage S66. Upon termination of the flowchart 60, WORM file volume WFV(1) would have been deleted from WORM disk media 23(1) and files G and H will still be securely stored within WORM file volume WFV(4) on WORM disk media 23(4) during its volume retention period.

From the preceding description of FIGS. 1-8, those having ordinary skill in the art will appreciate numerous advantages of the present invention. Foremost among such advantages is the layered protection of files A-H from deletion prior to and upon the volume retention end date via a command from an administrator of server 20 or via file system calls from users of a network incorporating the present invention as shown in FIG. 1. Additionally, a reclaiming of files can be performed safely and efficiently during the volume reclamation period, which is a time interval of the volume retention period as previously described herein.

Referring to FIG. 1, in one practical embodiment, manager 10 is embodied in a software module integrated with a commercially available storage-management software application entitled “IBM Tivoli Storage Manager” and a commercially available storage-management hardware application entitled “Network Appliance SnapLock”. As such, manager 10 is installed along with the aforementioned applications within a memory of a server or distributed among various server memories whereby the server processor(s) can execute manager 10 to perform various operations of the present invention as exemplary illustrated in FIGS. 2-8.

Manager 10 as a software module can be written in any conventional programming language by those having ordinary skill in the art appreciating the description herein of FIGS. 2-9. Nonetheless, the following client archive algorithm is provided solely for purposes of describing an example implementation of flowchart 40 (FIG. 3) in determining a volume reclamation period:

“Begin client session

Begin transaction

While there are files to be read from client

Read file from client
FileExpirationDate = CurrentDate + PolicyRetentionValue
Open WORM file volume for output

If output volume is a new scratch allocation

If first file from client

EndReclaimPeriod = FileExpirationDate +
ReclaimPeriod
BeginReclaimPeriod = FileExpirationDate

else

if (EndReclaimPeriod <
(FileExpirationDate + ReclaimPeriod))

EndReclaimPeriod =
(FileExpirationDate + ReclaimPeriod)
BeginReclaimPeriod =
FileExpirationDate

else output volume is a continuation allocation

if (EndReclaimPeriod < (FileExpirationDate +
ReclaimPeriod))

EndReclaimPeriod = (FileExpirationDate +
ReclaimPeriod)
BeginReclaimPeriod = FileExpirationDate

End while files to be read from client

End Transaction( )
Commit the BeginReclaimPeriodDate, EndReclaimPeriodDate to
server database
Set SnapLock end retention date to EndReclaimPeriodDate +
an additional time

period
End Client Session”

Additionally, the following client archive algorithm is provided solely for purposes of describing an example implementation of flowchart 40 (FIG. 3) in determining a volume retention date for a WORM file volume:

“Copying data to WORM file volumes

Begin process

Open WORM FILE volume for output
While files to move

Begin Transaction for each being moved

Copy file to output volume
RemainingFileRetentionTime =
PolicyRetentionValue − (CurrentDate−

DateStored to TSM)

FileRetentionDate = CurrentDate +
RemainingFileRetentionTime
if (FileRetentionDate > BeginReclaimPeriodDate)

EndReclaimPeriodDate = FileRetentionDate +
ReclaimPeriod
BeginReclaimPeriodDate = FileRetentionDate

End Transaction( )
Commit the BeginReclaimPeriodDate,
EndReclaimPeriodDate to the TSM

database

Set SnapLock retention period to
EndReclaimPeriodDate

End While file to move

End process”

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A signal bearing medium tangibly embodying a program of machine-readable instructions executable by at least one processor to perform operations to protect and manage a plurality of files within a WORM file volume, the operations comprising:
establishing a volume retention period for securely storing the files within the WORM file volume on a WORM media based on a file retention end date of each file within the WORM file volume;
securely storing the WORM file volume on the WORM media during the volume retention period;
establishing a volume reclamation period for reclaiming unexpired files within the WORM file volume prior to an expiration of the volume retention period based on the file retention end date of each file within the WORM file volume; and
reclaiming each unexpired file within the WORM file volume from the WORM media during the volume reclamation period.

2. The signal bearing medium of claim 1, wherein the WORM media is a WORM disk media.

3. The signal bearing medium of claim 1, further comprising:
reallocating a volume space previously occupied by the WORM file volume of the WORM media subsequent to the reclaiming of each unexpired file within the WORM file volume from the WORM media during the volume reclamation period.

4. The signal bearing medium of claim 1, wherein a volume retention end date of the volume retention period is equal to a summation of a latest file retention end date among the file retention end dates of the files and a specified time unit.

5. The signal bearing medium of claim 1, wherein the volume reclamation period is based on the file retention end date of at least one file within the WORM file volume.

6. The signal bearing medium of claim 1, wherein a volume reclamation begin date of the volume reclamation period is equal to a latest file retention end date among the file retention end dates of the files.

7. The signal bearing medium of claim 1, wherein a volume reclamation end date of the volume reclamation period is equal to a summation of a latest file retention end date among the file retention end dates of the files and a specified time unit.

8. The signal bearing medium of claim 1, wherein a volume reclamation end date of the volume reclamation period and a volume retention end date of the volume retention period are identical.

9. A system, comprising:
at least one processor; and
at least one memory storing instructions operable with the at least one processor for protecting and managing a plurality of files within a WORM file volume, the instructions being executed for:
establishing a volume retention period for securely storing the files within the WORM file volume on a WORM media based on a file retention end date of each file within the WORM file volume;
securely storing the WORM file volume on the WORM media during the volume retention period;
establishing a volume reclamation period for reclaiming unexpired files within the WORM file volume prior to an expiration of the volume retention period based on the file retention end date of each file within the WORM file volume; and
reclaiming each unexpired file within the WORM file volume from the WORM media during the volume reclamation period.

10. The system of claim 9, wherein the WORM media is a WORM disk media.

11. The system of claim 9, wherein the instructions are further executed for:
reallocating a volume space previously occupied by the WORM file volume of the WORM media subsequent to the reclaiming of each unexpired file within the WORM file volume from the WORM media during the volume reclamation period.

12. The system of claim 9, wherein a volume retention end date of the volume retention period is equal to a summation of a latest file retention end date among the file retention end dates of the files and a specified time unit.

13. The system of claim 9, wherein the volume reclamation period is based on the file retention end date of at least one file within the WORM file volume.

14. The system of claim 9, wherein a volume reclamation begin date of the volume reclamation period is equal to a latest file retention end date among the file retention end dates of the files.

15. The system of claim 9, wherein a volume reclamation end date of the volume reclamation period is equal to a summation of a latest file retention end date among the file retention end dates of the files and a specified time unit.

16. The system of claim 9, wherein a volume reclamation end date of the volume reclamation period and a volume retention end date of the volume retention period are identical.

17. A server for protecting and managing a plurality of files in a WORM file media, comprising:
means for establishing a volume retention period for securely storing the files within the WORM file volume on a WORM media based on a file retention end date of each file within the WORM file volume;
means for securely storing the WORM file volume on the WORM media during the volume retention period;
means for establishing a volume reclamation period for reclaiming unexpired files within the WORM file volume prior to an expiration of the volume retention period based on the file retention end date of each file within the WORM file volume; and
means for reclaiming each unexpired file within the WORM file volume from the WORM media during the volume reclamation period.

18. The server of claim 17, wherein the WORM media is a WORM disk media.

19. The server of claim 17, further comprising:
means for reallocating a volume space previously occupied by the WORM file volume of the WORM media subsequent to the reclaiming of each unexpired file within the WORM file volume from the WORM media during the volume reclamation period.

20. The server of claim 17, wherein a volume retention end date of the volume retention period is equal to a summation of a latest file retention end date among the file retention end dates of the files and a specified time unit.

21. The server of claim 17, wherein the volume reclamation period is based on the file retention end date of at least one file within the WORM file volume.

22. The server of claim 17, wherein a volume reclamation begin date of the volume reclamation period is equal to a latest file retention end date among the file retention end dates of the files.

23. The server of claim 17, wherein a volume reclamation end date of the volume reclamation period is equal to a summation of a latest file retention end date among the file retention end dates of the files and a specified time unit.

24. The server of claim 17, wherein a volume reclamation end date of the volume reclamation period and a volume retention end date of the volume retention period are identical.
